(19) United States
(12) Patent Application Publication
(10) Pub. No.: US 2018/0262793 A1
(43) Pub. Date: Sep. 13, 2018

(54) Reverse Casting from a First Screen Device to a Second Screen Device

(71) Applicant: Google Inc., Mountain View, CA (US)

(72) Inventors: Stephen Lau, Oakland, CA (US); Joon-Hee Jeon, Palo Alto, CA (US); Dhruv T. Amin, San Francisco, CA (US)

(73) Assignee: Google Inc., Mountain View, CA (US)

(21) Appl. No.: 15/455,005

(22) Filed: Mar. 9, 2017

(51) Int. Cl. H04N 21/43; H04W 4/02; H04N 21/422; H04N 21/45; H04N 21/81; H04N 21/4722; H04N 21/44; H04N 21/2187; H04N 21/439

(52) U.S. Cl. CPC H04N 21/4307; H04W 4/023; H04N 21/42209; H04N 21/4524; H04N 21/8113; H04N 21/4722; H04N 21/44008; H04N 21/2187; H04N 21/439; H04N 21/8133

(57) ABSTRACT

In aspects of reverse casting from a first screen device to a second screen device, a mobile device implemented as the second screen device can determine that it is proximate in location to the first screen device, such as a television device, based on both the mobile device and the television device being connected to a local network. The mobile device and the television device can be automatically associated to enable data being synchronized between the two devices based on determining that the devices are proximate in location. The television device displays video content prior to the two devices being associated. The mobile device can then receive contextual information that corresponds to the video content being displayed on the television device. The contextual information can be determined by an automated analysis of the video content at a video content service as the video content is distributed to the television device.

### FIELD OF INVENTION

This application generally relates to streaming video content, and reverse casting from a first screen device to a second screen device.

### BACKGROUND

Many device users have electronic and computing devices, such as mobile phones, tablet computers, multimedia devices, and other similar devices. These types of computing devices are increasingly utilized as television display devices, and video content streaming of live television and/or recorded video content is ever more commonplace. Mobile devices and other types of these computing devices are rapidly evolving to accommodate the users who want to stream video content on their mobile devices, as well as watch the same content on a larger screen television device. A user of a mobile device can initiate video content being displayed on a television device by utilizing the mobile device as a remote control to send a channel change command to the television device. Generally, a mobile device used as a remote control of a television device will know the television channel of the video content that is being displayed on the television device if the television channel is initiated from the mobile device. However, viewers often initiate watching television with a television remote control for a specific television device, or from the television itself, in which case there is no correlation between the television device and a mobile device of the viewer.

### SUMMARY

This document describes techniques and apparatuses for reverse casting from a first screen device to a second screen device. In one aspect, a method for reverse casting from a first screen device to a second screen device includes determining that the second screen device enters a location proximate to the first screen device based on the first screen device being connected to a local network and the second screen device entering the location and connecting to the local network. The method includes associating the second screen device with the first screen device based on the determination that the second screen device enters the location proximate to the first screen device, where the first screen device displays video content prior to the associating, and the associating the devices enables data being synchronized between the first and second screen devices. The method also includes receiving, at the second screen device, contextual information that corresponds to the video content being displayed on the first screen device.

In another aspect, a method for reverse casting from a first screen device to a second screen device includes displaying a synchronization user-selectable control in a user interface on the second screen device, and determining that the second screen device enters a location proximate to the first screen device based on the first screen device being connected to a local network and the second screen device entering the location and connecting to the local network. The method includes associating the second screen device with the first screen device to enable data being synchronized between the first and second screen devices responsive to a user input of the synchronization user-selectable control, the first screen device displaying video content prior to the associating the devices. The method also includes receiving, at the second screen device, content identification of the video content being displayed on the first screen device, the content identification being received from the first screen device.

In another aspect, a mobile device is implemented as a second screen device for reverse casting from a first screen device to the second screen device. The mobile device includes an integrated display to display contextual information that corresponds to video content being displayed on the first screen device. The mobile device also includes a memory and processor system to execute a content display application as a computer application that is implemented to determine that the second screen device is proximate in location to the first screen device, and associate the second screen device with the first screen device based on the second screen device being proximate in location to the first screen device. The first screen device displays the video content prior to the second screen device being associated with the first screen device, and the first and second screen devices are associated to enable data being synchronized between the first and second screen devices. The content display application is also implemented to receive the contextual information from a video content service that distributes, to the first screen device, the video content being displayed on the first screen device.

In yet another aspect, a mobile device implemented as a second screen device for reverse casting from a first screen device to the second screen device includes means for displaying contextual information that corresponds to video content being displayed on the first screen device; means for determining that the second screen device is proximate in location to the first screen device; means for associating the second screen device with the first screen device based on the second screen device being proximate in location to the first screen device, where the first screen device displays the video content prior to the second screen device being associated with the first screen device, and the first and second screen devices are associated to enable data being synchronized between the first and second screen devices; and means for receiving the contextual information from a video content service that distributes, to the first screen device, the video content being displayed on the first screen device.

This summary is provided to introduce simplified concepts for reverse casting from a first screen device to a second screen device, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Aspects of reverse casting from a first screen device to a second screen device are described with reference to the following Figures. The same numbers may be used throughout to reference like features and components that are shown in the Figures:

FIG. 1 illustrates an example video content viewing system in which aspects of reverse casting from a first screen device to a second screen device can be implemented as described herein.

FIG. 2 further illustrates example devices that can be implemented in the video content viewing system for reverse casting from a first screen device to a second screen device as described herein.

FIG. 3 illustrates an example system of devices in which aspects of reverse casting from a first screen device to a second screen device can be implemented as described herein.

FIG. 4 illustrates example method(s) of reverse casting from a first screen device to a second screen device in accordance with techniques described herein.

FIG. 5 illustrates example method(s) of reverse casting from a first screen device to a second screen device in accordance with techniques described herein.

FIG. 6 illustrates an example system with an example device that can implement reverse casting from a first screen device to a second screen device as described herein.

### DETAILED DESCRIPTION

### Overview

Reverse casting from a first screen device to a second screen device is described, and the features are implemented to associate the second screen device (e.g., a mobile device) with the first screen device (e.g., a television display device) after the first screen device is already displaying video content. For example, a person may initiate watching video content, such as a television program, on the television display device. A television program channel may be selected by the person with a remote control of the television display device, or the television program channel may be selected directly from the television device itself. Subsequent to the television program channel being selected and the television program being displayed for viewing on the television display device, a user of a mobile device may come home or walk into the room where the television display device is located and others are already watching television. In this instance, there is no correlation between the first screen device (e.g., the television display device) and the second screen device (e.g., the mobile device).

A “second screen experience” generally involves video content being displayed on a first screen device (e.g., a television display device) while additional content that is related to the video content is available for viewing and/or interaction on a second screen device (e.g., a mobile device), providing an enhanced viewing experience. Casting technology is a developed technique in which the mobile device, such as a mobile phone or tablet device, can be used to initiate and control playback of media content, such as the video content, Internet-streamed content, television program content, recorded media content, and the like on the television display device. A cast device, such as in the form of a dongle that connects via an HDMI port on the television display device, or integrated in the television display device itself, receives the control and playback commands from a mobile application installed on the mobile device, where both the cast device and the mobile device connect via a Wi-Fi network, such as an in-home network over which the devices can communicate with each other. The casting technology is designed for a user to control the playback of media content on the television display device using a mobile device.

However, the developed techniques for the casting technology do not take into account the scenario described above in which the first screen device (e.g., a television display device) is already displaying video content prior to the second screen device (e.g., a mobile device) being associated or correlated with the television display device. The features of reverse casting, as described herein, provide that the mobile device can be associated with the television display device to enable data and content being synchronized between the two devices. For example, the television display device is associated with the mobile device for data communication with the mobile device, and the mobile device can receive video content identification from the television display device and “catch up” to what is already being displayed on the television display device. Further, even while a user is watching video content on the television display device, a channel change may be initiated with the television remote control that is designed specifically for the television display device. Again, the user's mobile device will not be aware that the channel has been changed on the television display device until the television display device communicates back to the mobile device an update corresponding to the channel change on the television display device.

Each of the respective devices can include an instantiation of control logic, or a control application (e.g., a mobile phone app and/or a cast device), that associates the mobile device with the television display device for wired or wireless data communication, to include video content and other media content, via a network. The devices association pairs the devices for communication, such as direct communication via Bluetooth™ or other short-range communication technology, or communication via a Wi-Fi network to which both of the devices are connected. The devices association provides that the television display device can communicate information, data, and media content as a reverse cast back to the mobile device, such as content identification of the video content that is being displayed on the television display device.

In aspects of reverse casting from a first screen device to a second screen device, a mobile device implemented as the second screen device can determine that it is proximate in location to the first screen device, such as a television display device, based on both the mobile device and the television display device being connected to a local network. For example, a viewer who has a video content viewing system with a mobile device that is often used for a second screen experience and/or as a remote control of a television display device will have the devices configured as part of an in-home network (e.g., a Wi-Fi network) with a router device that provides for wired and/or wireless communication between the devices. The mobile device and the television display device can then be automatically associated based on a determination that the mobile device enters a location proximate to the television display device when the television display device is connected to the local network and the mobile device enters the location and connects to the local network. Alternatively, a synchronization user-selectable control may be displayed as a user-selectable control in a user interface on the mobile device, and when device association is initiated with a user input of the synchronization user-selectable control, such as with a touch input in the user interface on an integrated display of the mobile device, the mobile device and the television display device are associated to enable data and content being synchronized between the first and second screen devices.

As noted above, the television display device may be displaying video content prior to the devices being associated, and the association of the mobile device with the television display device occurs after the television display device is already displaying the video content. Prior to the devices being associated, the mobile device does not know what the video content is that is being displayed on the television display device, such as if a television channel on the television display device was selected with a remote control of the television, or if the television channel was selected directly from the television display device itself. When the mobile device and the television display device are associated, either automatically by the control logic or control application that is implemented in each of the respective devices, such as based on the determination that the mobile device is proximate in location to the television display device, or when initiated by the user, the mobile phone can then be used as a remote control of the television display device.

Additionally, the mobile device can begin receiving contextual information that corresponds to the video content being displayed on the television display device. The mobile device may also receive content identification, from the television display device, of the video content that is being displayed on the television display device, and the mobile device can then initiate a request, based on the content identification of the video content, for the contextual information that corresponds to the video content being displayed on the television display device.

The contextual information can be displayed on the mobile device as media content options to display media content that is related to the video content being displayed on the television display device. For example, a user may be watching the news on the television display device and a story about a particular event is being reported. The contextual information received and displayed on the mobile device may be user selections for any type of related media content, such as another news organization's reporting of the news event, a video clip of the news event recorded by a witness, a video clip of an eyewitness accounting of the news event, a still image or images of the news event, an audio recording of the news event, and so on. The contextual information that is received and displayed on the mobile device can be any type of media content, such as video, audio, and/or image content, as well as purchasable media content including other video content, music content, and image content that a user can initiate purchasing from the mobile device. The contextual information is displayed on the mobile device as any relevant information, data, and/or content that a user may find interesting while also watching video content on the television display device.

The video content that is being displayed for viewing on the television display device may be any type of media content, such as recorded video content, Internet-streamed content, television program content, live media content, and/or can be live television programming, and the like. The contextual information that corresponds to the video content, such as a live television program, can be received in real-time at the mobile device. In implementations, the contextual information is determined by an automated analysis of the video content at a video content service as the video content is distributed to the television display device. The mobile device also receives the contextual information from the video content service, such as when the video content service analyzes a live television program, determines the contextual information that is related to the live television program, and distributes the contextual information to the mobile device. Notably, the video content that is being displayed on the television display device includes audio data and video data, and the related contextual information can correspond to the audio data and/or correspond to the video data. For example, the video content that is being displayed on the television display device may include a music track as audio data of the video content, and the contextual information displayed on the mobile device includes a music video clip of the music track playing in the video content on the television display device.

While features and concepts of reverse casting from a first screen device to a second screen device can be implemented in any number of different devices, systems, networks, environments, and/or configurations, aspects of reverse casting from a first screen device to a second screen device are described in the context of the following example devices, systems, and methods.

### Example Systems

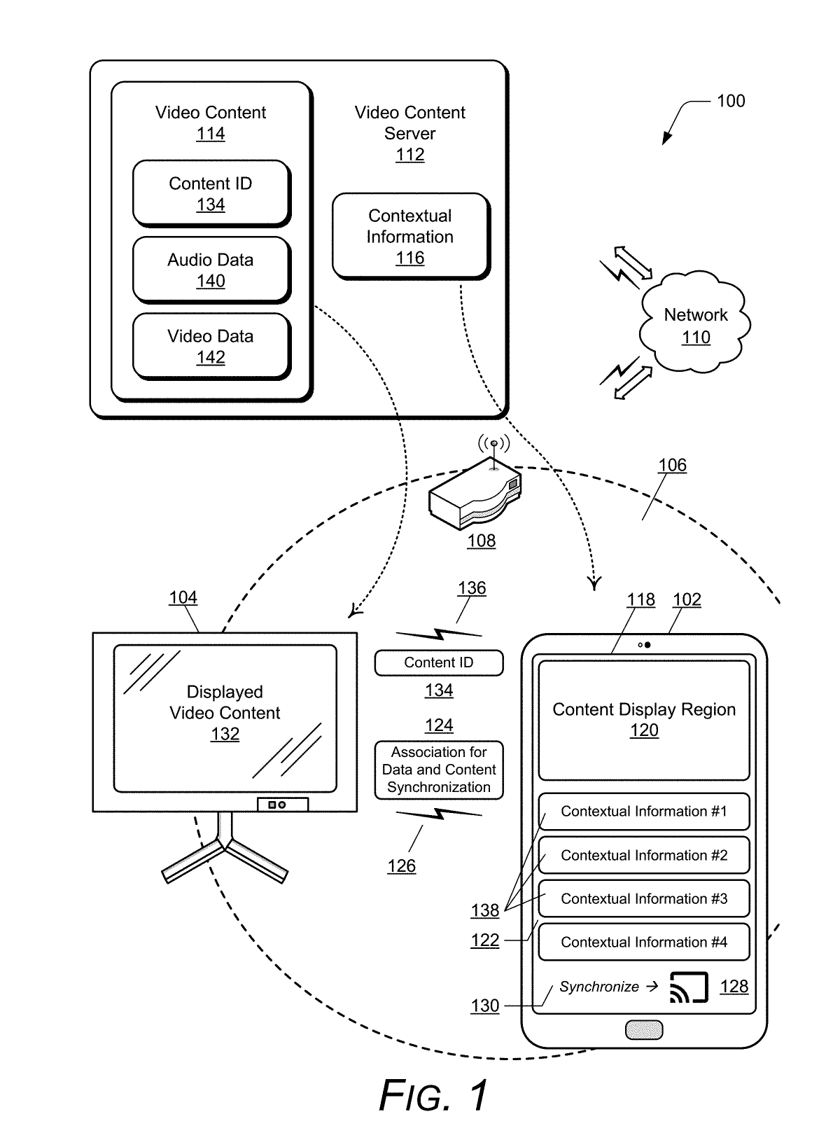

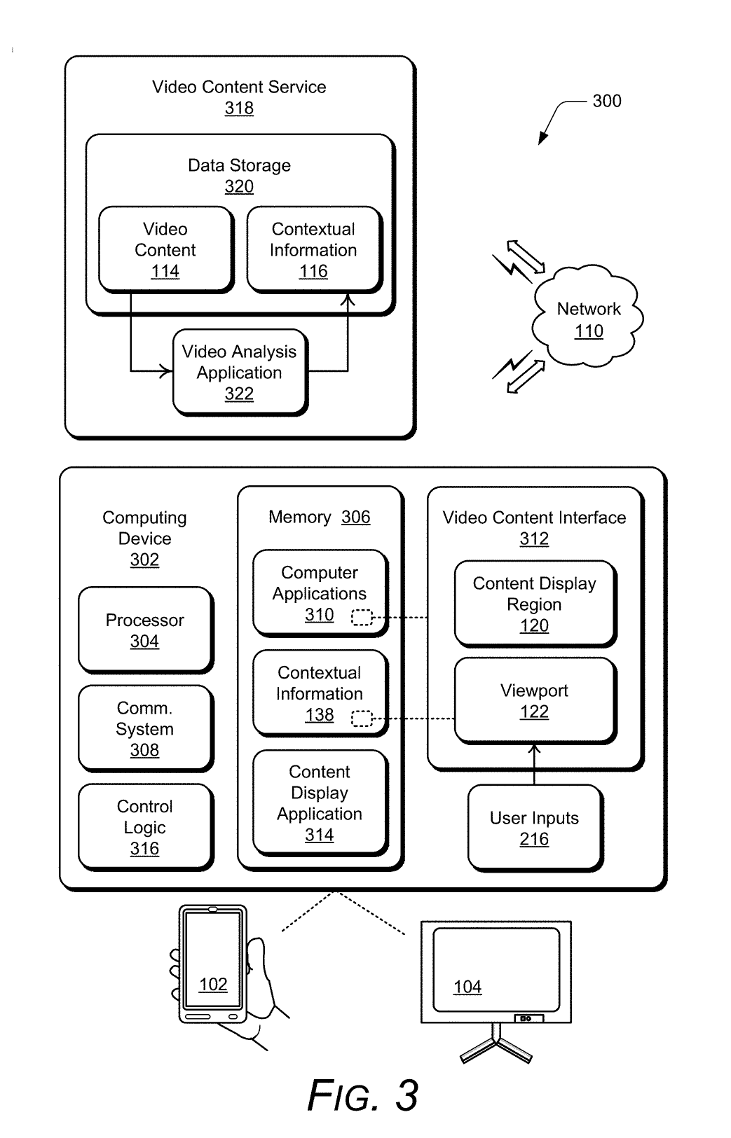

FIG. 1 illustrates an example video content viewing system 100 in which aspects of reverse casting from a first screen device to a second screen device can be implemented. The example system 100 includes a mobile device 102, shown as a mobile phone, and generally referred to herein as the second screen device of the system. The example system also includes a television display device 104, shown as being remote from the mobile device 102, and generally referred to herein as the first screen device in the system. Although generally referred to as a television, the television display device 104 represents any type of display panel, display device, computer display, smart television, and the like that can receive, process, and display any type of media content, such as streaming video content, Internet-streamed content, recorded media content, television program content, live television programming, live Internet-streamed content, and the like. Further, the mobile device 102 is representative of any type of computing device that may be utilized as a second screen device in the video content viewing system 100 for a “second screen experience” using a mobile phone, tablet device, or similar mobile device, such as described with reference to the computing device shown in FIG. 3.

In this example, the mobile device 102 and the television display device 104 are configured as part of an in-home network 106 (e.g., a Wi-Fi network) with a router device 108 implemented as an access point that provides for wired and/or wireless communication between the devices, as well as network connectivity via a network 110. Additionally, a cast device for streaming content, such as in the form of a dongle that connects via an HDMI port on the television display device 104, or integrated in the television display device itself, communicates with a mobile application (e.g., “mobile app”) installed on the mobile device 102. Both the cast device of the television display device 104 and the mobile device 102 can connect via a Wi-Fi network, or are in communication via a wired connection, such as through a gaming and/or media console device.

The example system 100 also includes a video content server 112 from which video content 114 can be distributed to the mobile device 102 and to the television display device 104 via the network 110 and the router device 108 in the in-home network 106. Similarly, contextual information 116 that is determined as being related to video content 114 at the video content server 112 can be distributed to the mobile device 102 via the network 110 and the router device 108 in the in-home network 106. The video content server 112 is also generally referred to as a back-end server and in implementations, may be a server device of a cloud-based service from which the video content 114 and/or the contextual information 116 can be requested and distributed to devices that render and display any of the various types of media content, such as the video content that is displayed on the television display device 104.

Any of the devices, servers, and/or services described herein can communicate via the network 110, such as for data communication between the mobile device 102 and the video content server 112, and between the television display device 104 and the video content server 112. The network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The mobile device 102 has an integrated display 118, which can be used to display media content in a content display region 120 of the integrated display. The media content that is displayable in the content display region 120 can include video content, such as live television content, recorded video content, and on-demand content, Internet-streamed content, as well as images, graphics, and any other type of data or information related to video content that is received by the mobile device 102 and/or displayed on the integrated display 118 of the mobile device. The integrated display 118 also has a viewport 122, or viewport region of the display, which can also be used to display any type of media content, such as video content and information or data related to the video content (e.g., the contextual information 116).

The mobile device 102 can determine that it is proximate in location to the television display device 104 based on both the mobile device and the television device being connected for wired and/or wireless communication in the in-home network 106 (e.g., a Wi-Fi network). The mobile device 102 and the television display device 104 can then be automatically associated 124 via wireless communication 126 (e.g., via the router device 108), such as based on the determination that the mobile device is proximate in location to the television display device when both devices are connected to the local network. Alternatively or in addition, the television display device 104 and the mobile device 102 may be associated or correlated for communication via any type of wired or wireless communication technique, such as via peer-to-peer (P2P), Bluetooth®, Whisper®, Wi-Fi Direct (Wi-Fi P2P), and the like.

The television display device 104 can be associated for content and data communication with the mobile device 102 so that the mobile device can receive video content identification from the television display device as to the video content that is already being displayed on the television display device 104 when the devices are associated to enable the data and/or content synchronization. Each of the respective devices can include an instantiation of control logic, or a control application (e.g., a mobile phone app and/or a cast device), that associates the mobile device 102 with the television display device 104 for wired or wireless data communication in the network 106. The devices association pairs the devices for communication and provides that the television display device 104 can communicate information and data, such as video content identification, as well as any type of media content as a reverse cast back to the mobile device 102. The control logic or control application of the devices can be implemented to determine that the respective devices are proximate in location based on the devices mutual connection to the in-home network 106. Alternatively or in addition, the control logic or control application of the mobile device 102 may be implemented to discover the nearby cast device of the television display device 104, such as based on a signal emitted from the cast device and/or based on sync settings of the respective devices control application.

As further detailed in the system description of the example system shown in FIG. 3, the mobile device 102 implements a content display application (e.g., as a module, a component, a software application, etc.) that implements techniques of reverse casting as described herein. Similarly, the television display device 104 can implement an instance of the content display application, such as in a smart television or other display device that is configured as a computing device. As noted above, each of the respective devices can include an instantiation of control logic, or a control application (e.g., a mobile phone app and/or a cast device), that associates the mobile device with the television display device for wired or wireless data communication. The cast device, such as in the form of a dongle that connects via an HDMI port on the television display device 104, or integrated in the television display device itself, communicates with a mobile application installed on the mobile device, where both the cast device and the mobile device connect via the Wi-Fi network, or by other direct communication systems. In the described techniques, the content display application on the mobile device 102 can determine that the mobile device is proximate in location to the television display device 104 (e.g., based on the respective network connections of the devices, or based on emitted signals from the devices). The content display application, or other device application, can then initiate the association 124 of the mobile device 102 and television display device 104.

As an alternative to being automatically synchronized, a synchronization user-selectable control 128 may be displayed as a user-selectable control in the user interface 130 on the mobile device 102. When a user initiates to associate or correlate the mobile device 102 with the television display device 104 with a user input of the synchronization user-selectable control 128, such as a touch input in the user interface 130 on the integrated display 118 of the mobile device, the mobile device 102 and the television display device 104 are associated 124 via wireless communication 126. When the devices are associated by the control logic or control application that is implemented by each of the respective devices, the mobile device 102 and the television display device 104 can exchange data and content via wired and/or wireless communication in the network 106.

When the mobile device 102 and the television display device 104 are associated 124, such as based on the determination that the mobile device is proximate in location to the television display device or when initiated by the user, the mobile phone 102 can then be used as a remote control of the television display device. As noted above, the mobile device 102 and the television display device 104 can exchange data and content via wired and/or wireless communication in the network 106 when the devices are associated or correlated to enable data synchronization. Additionally, the mobile device can begin receiving the contextual information 116 that corresponds to the video content 132 being displayed on the television display device. The mobile device 102 may also receive content identification 134 of the video content 132 that is being displayed on the television display device 104. The content identification 134 can be received from the television display device 104 via wireless communication 136 (e.g., through the router device 108), and the mobile device 102 can then initiate a request to the video content server 112, based on the content identification 134 of the video content 132, for the contextual information 116 that corresponds to the video content 132 being displayed on the television display device 104.

The contextual information 116 that corresponds or is related to a particular video content 114 can be any type of media content, such as video, audio, and/or image content, as well as purchasable media content including other video content, music content, and image content that a user can initiate purchasing from the mobile device. In this example, the contextual information 116 can be received from the video content server 112 and displayed in the viewport 122 on the integrated display 118 of on the mobile device 102 as contextual information 138. Generally, the contextual information 138 is displayed or may be selectable by a user of the mobile device 102, such as to initiate displaying any of the contextual information 116 as media content that is related to the video content 132 being displayed on the television display device 104. The selected contextual information 138 can also be displayed in the content display region 120 on the integrated display 118 of the mobile device.

For example, a user may be watching a news program as the displayed video content 132 on the television display device 104 and a story about a particular event is being reported. The contextual information 116 is received and displayed on the mobile device 102 as the contextual information 138 for user selection of any type of related media content, such as another news organization's reporting of the news event, a video clip of the news event recorded by a witness, a video clip of an eyewitness accounting of the news event, a still image or images of the news event, an audio recording of the news event, and so on. The contextual information 116 that is received and displayed on the mobile device 102 can be any type of media content, such as video, audio, and/or image content, as well as purchasable media content including video content, music content, and image content that a user can initiate purchasing from the mobile device.

The video content 132 that is being displayed on the television display device 104 may be a live television program, and the contextual information 116 that corresponds to the live television program is received in real-time at the mobile device 102. In implementations, the contextual information 116 is determined at a video content service by an automated analysis of the video content 114 as it is distributed to the television display device. In this example, the video content 114 is distributed to the television display device 104 from the video content server 112, and is displayed as the video content 132 on the television display device. As further detailed in the system description of the example system shown in FIG. 3, a video content service implements a video analysis application (e.g., as a module, a component, a software application, etc.) that implements techniques of the features described herein. In the described techniques, the video analysis application at the video content service can determine the contextual information 116 that corresponds or is related to particular video content 114.

The mobile device 102 also receives the contextual information 116 from the video content server 112, such as when the video analysis application at the video content service analyzes a live television program (e.g., video content 114), determines the contextual information 116 that is related to the live television program, and distributes the contextual information to the mobile device. Notably, the video content 132 that is being displayed on the television display device 104 includes audio data 140 and video data 142, and the related contextual information 116 can correspond to the audio data and/or to the video data. For example, the video content 132 that is being displayed on the television display device 104 may include a music track as audio data 140 of the video content, and the contextual information 116 that is displayed on the mobile device 102 as the contextual information 138 includes a music video clip of the music track playing in the video content on the television display device.

In addition to the examples noted above, the contextual information 116 that corresponds or is related to particular video content 114 can include video clips, other videos, news articles, press releases, maps, clippings, on-line articles or links to on-line Internet content, news feeds, and any other contextual information that may be relevant to the video content 132 that is currently being displayed on the television display device 104. For example, a viewer may be watching a sporting event as the video content 132 that is currently being displayed on the television display device 104, and when a participant in the sporting event performs a particular action during the event, such as stealing the ball or scoring points, past highlights of the participant, statistics of the participant updated dynamically in real-time, and any other information related to the participant can be displayed as the contextual information 138 on the mobile device 102. Similarly, if the viewer is watching the television display device 104 and a television commercial comes on, such as a commercial for a pizza restaurant, the contextual information 138 that is received and displayed on the mobile phone 102 can include a map to the pizza restaurant (allowing for navigation), a telephone link to initiate a call to the restaurant, a selectable link to the pizza restaurant's on-line Web site, and/or a link to download the pizza restaurant's mobile phone application, so that the user can place an order for the product.

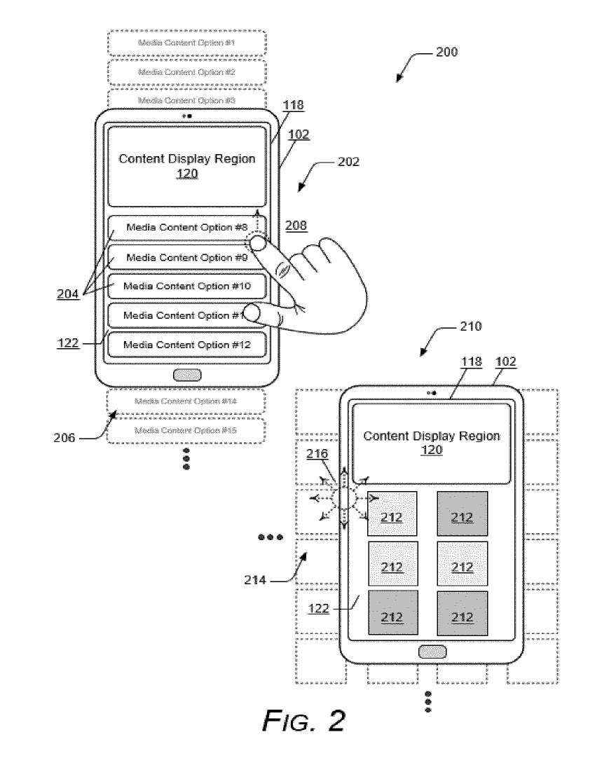

FIG. 2 further illustrates examples 200 of devices that can be implemented in the video content viewing system 100 for reverse casting from a first screen device to a second screen device as shown and described with reference to FIG. 1. In a first example 202, contextual information is displayed in the viewport 122 on the integrated display 118 of the mobile device 102 as media content or media content options 204 organized in a scrollable list 206 that includes any number of additional media content options of contextual information that are displayed and/or the user can select for viewing. For example, a navigation input 208 in the viewport 122 is received by the mobile device 102 as a user manipulation to scroll up the media content options 204 out of view through the viewport, and move additional media content options into view in the viewport 122. A user manipulation in the viewport 122 can be received by the mobile device to scroll up or scroll down the media content options that are displayed in the viewport 122 on the integrated display 118 of the mobile device.

In a second example 210, contextual information is displayed in the viewport 122 on the integrated display 118 of the mobile device 102 as media content or as media content options 212, shown organized as panels 214 in an arrangement that allows for user manipulation in the viewport 122 as a navigation input 216 up, down, left, right, diagonal, or any other direction to display other media content or media content options in the viewport. Generally, a navigation input may be initiated as an up or down scrolling, an up or down, or left or right lateral swiping motion, as a gesture or flicker (e.g., up, down, left, right), or as any other type of navigation input.

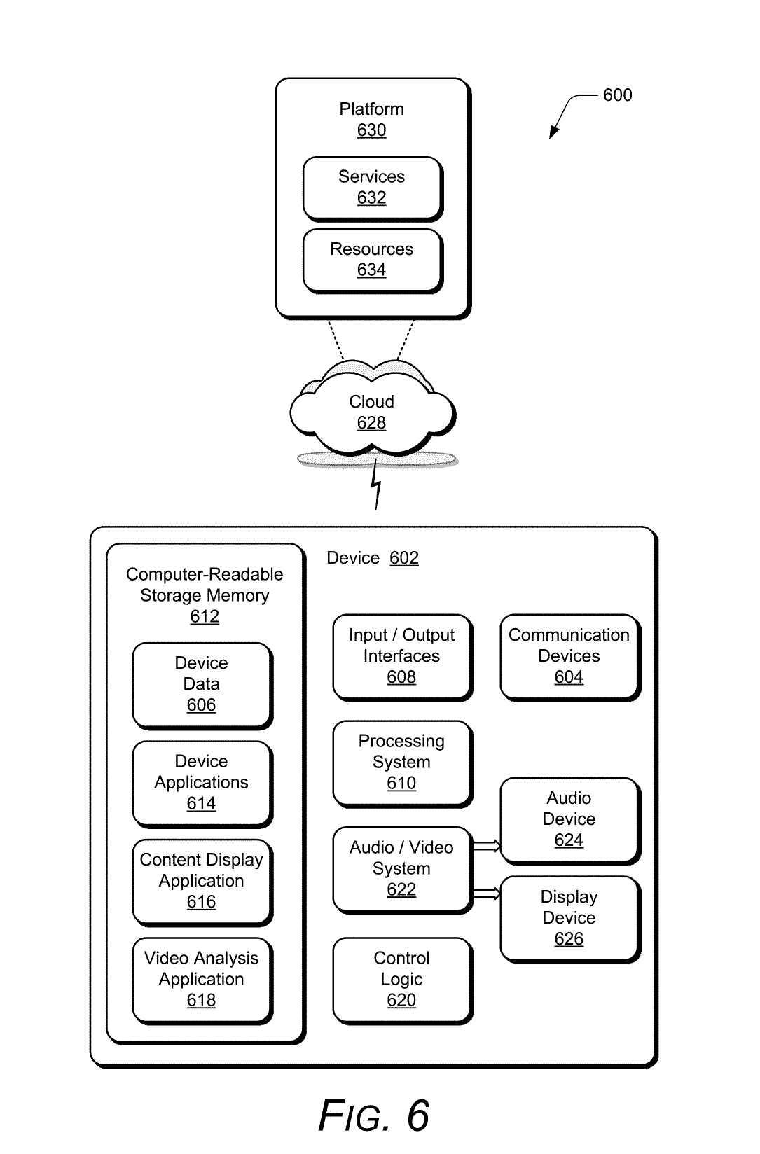

FIG. 3 illustrates an example system 300 of devices in which aspects of reverse casting from a first screen device to a second screen device can be implemented. The example system 300 includes a computing device 302, such as the mobile phone 102 and the television display device 104 as shown and described with reference to FIGS. 1 and 2. The computing device 302 may be implemented as any type of a mobile phone, tablet device, media playback, computing, communication, gaming, entertainment, portable electronic media device, or computer device. The computing device 302 can be implemented with various components, such as a processor 304 (or processing system) and memory 306, and with any number and combination of different components as further described with reference to the example device shown in FIG. 6.

Although not shown, the computing device 302 can include a power source, such as a battery, to power the various device components. Further, the computing device 302 can include different wireless radio systems, such as for Wi-Fi, Bluetooth™, Mobile Broadband, LTE, or any other wireless communication system or format. Generally, the computing device 302 implements a communication system 308 that includes a radio device, antenna, and chipset that is implemented for wireless communication with other devices, networks, and services.

The computing device 302 includes one or more computer applications 310 that generate a video content interface 312, which includes the content display region 120 and the viewport 122 in which the contextual information 138 is displayed, such as in the integrated display 118 of the mobile device 102. The computer applications 310 also include the content display application 314 that implements techniques of reverse casting as described herein.

The content display application 314 can be implemented as a software application or module, such as computer-executable software instructions that are executable with the processor 304 (or with a processing system) to implement the described techniques. The content display application 314 can be stored on computer-readable storage memory (e.g., the device memory 306), such as any suitable memory device or electronic data storage implemented in the computing device. Although shown as a separate module or component in memory 306, the content display application 314 may be integrated as a module or component with any of the computer applications 310.

As noted above, the mobile device 102 implemented as the second screen device in the video content viewing system 100 can determine that it is proximate in location to the television display device 104 implemented as the first screen device in the video content viewing system, such as based on both the mobile device and the television display device being connected in the local network 106 for wired and/or wireless communication. The mobile device 102 and the television display device 104 can then be automatically associated based on the determination that the mobile device is proximate in location to the television display device. For example, control logic 316 implemented on each of the respective devices, such as a software application, a cast device (e.g., a plug-in dongle or integrated component), or other implementation, can synchronize the mobile device 102 and the television display device 104 for wired or wireless data communication in the network 106. Although shown as a separate module or component, the control logic 816 may be integrated as software or a module of the computer applications 310 (e.g., as part of the operating system of the device), or may be implemented as a component or components of the communication systems 308 to synchronize and facilitate data communication between the respective devices.

The television display device 104 may be displaying the video content 132 prior to the devices being associated, and the association of the mobile device 102 with the television display device 104 occurs after the television display device is already displaying the video content 132. Prior to the devices being associated, the mobile device 102 does not know what the video content is that is being displayed on the television display device, such as if a television channel on the television display device was selected with a remote control of the television, or if the television channel was selected directly from the television display device itself. The association of the devices provides that the television display device 104 can communicate information, data, and any type of media content as a reverse cast back to the mobile device 102, such as content identification of the video content that is being displayed on the television display device 104 and which the mobile device 102 is previously unaware. In an implementation, the television display device 104 may also receive the contextual information 116 from the video content service 318, and then communicate the contextual information as a reverse cast to the mobile device via the network 106.

In the described techniques, the content display application 314 on the computing device 302 (e.g., implemented as the mobile device 102) can receive the contextual information 138 that corresponds to the video content 132 being displayed on the television display device 104. The content display application 314 may also receive the content identification 134 of the video content 132 that is being displayed on the television display device, and the content display application 314 can then initiate a request, based on the content identification 134 of the video content, for the contextual information 138 that corresponds to the video content being displayed on the television display device.

The example system 300 includes the video content service 318 (e.g., a cloud-based content service) that is accessible by the computing device 302 to request the video content 114 and the contextual information 116 that corresponds or is related to the video content 114. The video content service 318 includes data storage 320 that may be implemented as any suitable memory, memory device, or electronic data storage for network-based data storage. The data storage 320 can maintain the video content 114 and the contextual information 116. The video content service 318 can also be implemented with server devices (e.g., video content server 112) that are representative of one or multiple hardware server devices of the video content service. Further, the video content service 318 can be implemented with various components, such as a processing system and memory, as well as with any number and combination of different components as further described with reference to the example device shown in FIG. 6.

The video content service 318 also includes a video analysis application 322, which can be implemented as a software application or module, such as computer-executable software instructions that are executable with a processor (or with a processing system) to implement the described techniques. The video analysis application 322 can be stored on computer-readable storage memory (e.g., the data storage 320), such as any suitable memory device or electronic data storage implemented at the video content service.

In implementations, the video analysis application 322 performs an automated analysis of the video content 114 at the video content service 318 as the video content 114 is distributed to the television display device 104. The video analysis application 322 can be implemented to analyze the video content 114 for a determination of the corresponding or related contextual information 116 utilizing various techniques. For example, the video analysis application 322 can use content signals from the video, such as closed captions, audio analysis of the audio data and soundtracks, and image recognition techniques of the video data to recognize people, objects, events, and any other aspects of the video content. Notably, the various analysis techniques can be performed in real-time, such as on video content 114 that is live television content being distributed to a device for display.

### Example Methods

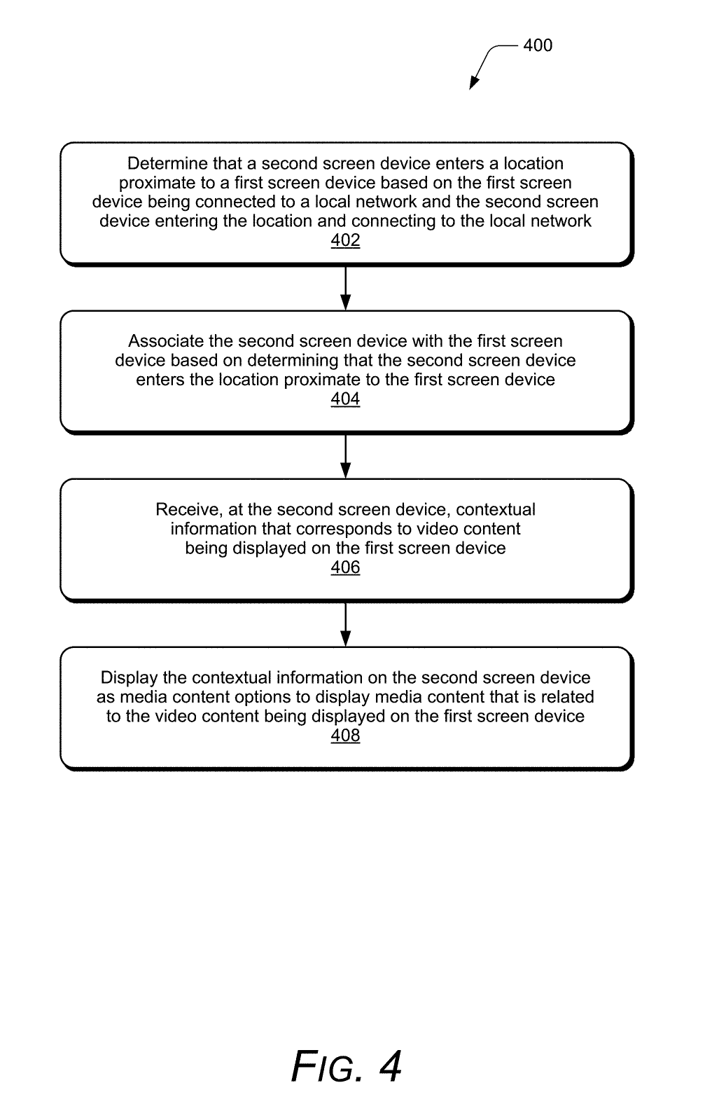

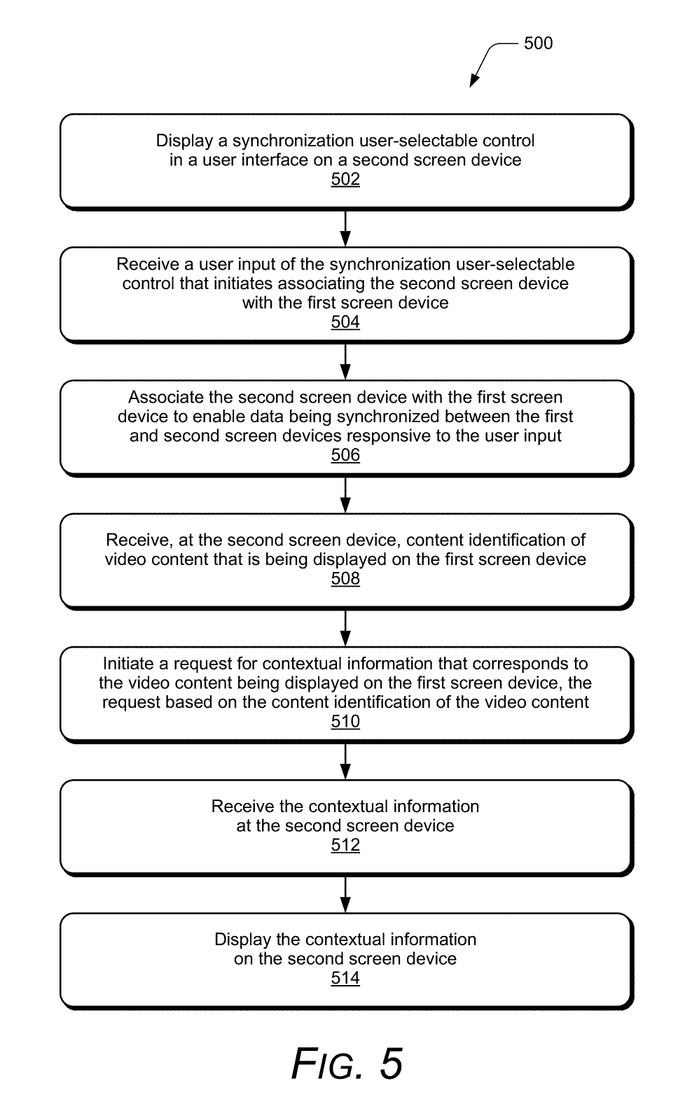

Example methods 400 and 500 are described with reference to respective FIGS. 4 and 5 in accordance with one or more aspects of reverse casting from a first screen device to a second screen device. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 of reverse casting from a first screen device to a second screen device, and is generally described with reference to the mobile phone or mobile device as a second screen device in a video content viewing system. The order in which the method is described is not intended to be construed as a limitation, and any number or combination of the method operations can be combined in any order to implement a method, or an alternate method.

At 402, a determination is made that a second screen device enters a location proximate to a first screen device based on the first screen device being connected to a local network and the second screen device entering the location and connecting to the local network. For example, the mobile device 102 is the second screen device in the video content viewing system 100, and the mobile device 102 determines that it is proximate in location to the television display device 104 based on both the mobile device and the television device being connected in the in-home network 106 (e.g., a Wi-Fi network), where the television display device 104 is the first screen device in the video content viewing system 100. The mobile device 102 enters the location proximate to the television display device 104 that is connected to the in-home network 106, and the mobile device then connects to the in-home network 106. Each of the respective devices can include an instantiation of the control logic, or a control application (e.g., a mobile phone app and/or a cast device), that associates the mobile device 102 with the television display device 104 for wired or wireless data communication in the network 106. The devices association pairs the devices for communication and provides that the television display device 104 can communicate information and data, as well as any type of media content, as a reverse cast back to the mobile device 102. The control logic 316 or control application of the devices can be implemented to determine that the respective devices are proximate in location based on the devices mutual connection to the in-home network 106. Alternatively or in addition, the control logic 316 or control application of the mobile device 102 may be implemented to discover the nearby cast device of the television display device 104, such as based on a signal emitted from the cast device and/or based on sync settings of the respective devices control application.

At 404, the second screen device is associated with the first screen device based on determining that the second screen device enters the location proximate to the first screen device. For example, the mobile device 102 and the television display device 104 are automatically associated 124 via wireless communication 126, such as based on the determination that the mobile device enters the location proximate to the television display device and both devices are connected to the local network 106. The control logic 316 that is instantiated in each of the respective devices associates the mobile device 102 and the television display device 104 for wired or wireless data communication in the network 106. The synchronization provides that the television display device 104 can communicate information, data, and any type of media content as a reverse cast back to the mobile device 102, such as the content identification 134 of the video content 132 that is being displayed on the television display device. Additionally, when the devices are paired for communication (e.g., associated) the mobile device 102, which is the second screen device in this example, can be used as a remote control of the television display device 104, which is the first screen device in this example, such as implemented with casting technology.

At 406, contextual information is received at the second screen device, where the contextual information corresponds to the video content being displayed on the first screen device. For example, the mobile device 102 receives the contextual information 116 that corresponds to the video content 132 being displayed on the television display device 104. The video content 132 that is being displayed on the television display device 104 can be a live television program, and the contextual information 116 that corresponds to the live television program is received in real-time at the mobile device 102. The contextual information 116 that corresponds or is related to a particular video content 114 can be any type of media content, such as video, audio, and/or image content, as well as purchasable media content including other video content, music content, and image content that a user can initiate purchasing from the mobile device. In this example, the contextual information 116 can be received from the video content server 112 and displayed in the viewport 122 on the integrated display 118 of on the mobile device 102 as the contextual information 138. Generally, the contextual information 138 is displayed or may be selectable by a user of the mobile device 102, such as to initiate displaying any of the contextual information 116 as media content that is related to the video content 132 being displayed on the television display device 104. In implementations, the contextual information 116 is determined by an automated analysis of the video content at the video content service 318 as the video content is distributed to the television display device 104 and the mobile device 102 receives the contextual information 116 from the video content service.

At 408, the contextual information is displayed on the second screen device as media content options to display media content that is related to the video content being displayed on the first screen device. For example, the mobile device 102 receives the contextual information 116 from the video content server 112, and the contextual information is displayed in the viewport 122 on the integrated display 118 of the mobile device 102 as the contextual information 138. The video content 132 that is displayed on the television display device 104 can include audio data 140 and video data 142, and the contextual information 138 corresponds to the audio data or the video data of the video content. For example, the video content 132 may include a music track, and the contextual information 138 includes a music video clip of the music track playing in the video content 132 on the television display device 104. Further, the contextual information 138 can be displayed on the mobile device 102 as multiple video options for video clips related to the video content 132 that is being displayed on the television display device. Further, the contextual information 138 can be displayed on the mobile device 102 as purchasable media content, including video content, music content, and image content.

FIG. 5 illustrates example method(s) 500 of reverse casting from a first screen device to a second screen device, and is generally described with reference to the mobile phone or mobile device as a second screen device in a video content viewing system. The order in which the method is described is not intended to be construed as a limitation, and any number or combination of the method operations can be combined in any order to implement a method, or an alternate method.

At 502, a synchronization user-selectable control is displayed in a user interface on a second screen device and, at 504, a user input of the synchronization user-selectable control is received that initiates associating the second screen device with the first screen device. For example, the synchronization user-selectable control 128 can be displayed as a user-selectable control in the user interface 130 on the mobile device 102. If the first and second screen devices are not automatically associated, a user of the mobile device 102 can initiate device association of the mobile device 102 with the television display device 104 with a user input of the synchronization user-selectable control 128, such as with a touch input in the user interface 130 on the integrated display 118 of the mobile device.

At 506, the second screen device is associated with the first screen device to enable data and content being synchronized between the first and second screen devices responsive to the user input of the synchronization user-selectable control. For example, the mobile device 102 and the television display device 104 are associated 124 for wired and/or wireless communication 126 to enable data and content synchronization when the user initiates associating the devices, such as with the user input of the synchronization user-selectable control 128 that is displayed in the user interface 130 on the integrated display 118 of the mobile device. The control logic 316 that is instantiated in each of the respective devices associates the mobile device 102 and the television display device 104 for wired or wireless data communication in the network 106, and the television display device 104 can communicate information, data, and any type of media content as a reverse cast back to the mobile device 102, such as the content identification 134 of the video content 132 that is being displayed on the television display device.

At 508, content identification of video content is received at the second screen device, where the content identification is of video content that is being displayed on the first screen device. For example, the mobile device 102 is the second screen device in the video content viewing system 100, and the mobile device 102 receives the content identification 134 of the video content 132 that is being displayed on the television display device 104, which is the first screen device in the video content viewing system. The mobile device 102 receives the content identification 134 from the television display device 104 via wireless communication 136, and the content identification 134 is received after the video content 132 is initiated for display on the television display device 104.

At 510, a request is initiated for contextual information that corresponds to the video content being displayed on the first screen device, the request based on the content identification of the video content. For example, the content display application 314 implemented by the mobile device 102 initiates a request to the video content server 112, based on the content identification 134 of the video content 132, for the contextual information 116 that corresponds to the video content 132 being displayed on the television display device 104.

At 512, the contextual information is received at the second screen device and, at block 514, the contextual information is displayed on the second screen device. For example, the mobile device 102 receives the contextual information 116 that corresponds to the video content 132 being displayed on the television display device 104. The mobile device 102 also displays the contextual information in the viewport 122 on the integrated display 118 of on the mobile device 102 as the contextual information 138.

### Example Device

FIG. 6 illustrates an example system 600 that includes an example device 602, which can implement aspects of reverse casting from a first screen device to a second screen device. The example device 602 can be implemented as any of the computing devices and/or services (e.g., server devices) described with reference to the previous FIGS. 1-5, such as any type of computing device, client device, mobile phone, tablet, communication, entertainment, gaming, media playback, and/or other type of device. For example, the mobile device 102, the television display device 104, the computing device 302, and/or server devices of the video content service 318 (e.g., a cloud-based service) may be implemented as the example device 602.

The device 602 includes communication devices 604 that enable wired and/or wireless communication of device data 606, such as video content identifiers, priority ordering of the video content, contextual information that corresponds or is related to particular video content, and other data and content that is transferred from one computing device to another, and/or synched between multiple computing devices. The device data can include any type of audio, video, image, and/or graphic data that is generated by applications executing on the device. The communication devices 604 can also include transceivers for cellular phone communication and/or for network data communication.

The device 602 also includes input/output (I/O) interfaces 608, such as data network interfaces that provide connection and/or communication links between the device, data networks, and other devices. The I/O interfaces can be used to couple the device to any type of components, peripherals, and/or accessory devices, such as a digital camera device that may be integrated with device 602. The I/O interfaces also include data input ports via which any type of data, media content, and/or inputs can be received, such as user inputs to the device, as well as any type of audio, video, and/or image data received from any content and/or data source.

The device 602 includes a processing system 610 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 602 may further include any type of a system bus or other data and command transfer system that couples the various components within the device. A system bus can include any one or combination of different bus structures and architectures, as well as control and data lines.

The device 602 also includes computer-readable storage memory 612, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 612 provides storage of the device data 606 and various device applications 614, such as an operating system that is maintained as a software application with the computer-readable storage memory and executed by the processing system 610. In this example, the device applications also include various computer applications and a content display application 616 that implements aspects of reverse casting from a first screen device to a second screen device, such as when the example device 602 is implemented as the mobile device 102, the television display device 104, and/or the computing device 302. An example of the content display application 616 is the content display application 314 that is implemented by the computing device 302, as shown and described with reference FIG. 3. The device applications 614 also include a video analysis application 618 that is implemented to analyze video content, such as any type of recorded video content and live television content, in aspects of the techniques described herein, such as when the example device 602 is implemented as the video content service 318. An example of the video analysis application 618 is the video analysis application 322 that is implemented at the video content service 318, as shown and described with reference FIG. 3. Additionally, the device 602 includes control logic 620, such as described with reference to control logic 316 in the computing device 302, and implemented to synchronize the mobile device 102 and the television display device 104 for wired or wireless data communication

The device 602 also includes an audio and/or video system 622 that generates audio data for an audio device 624 and/or generates display data for a display device 626. The audio device and/or the display device include any devices that process, display, and/or otherwise render audio, video, display, and/or image data, such as the image content of a digital photo. In implementations, the audio device and/or the display device are integrated components of the example device 602. Alternatively, the audio device and/or the display device are external, peripheral components to the example device. In embodiments, at least part of the techniques described for reverse casting from a first screen device to a second screen device may be implemented in a distributed system, such as over a “cloud” 628 in a platform 630. The cloud 628 includes and/or is representative of the platform 630 for services 632 and/or resources 634. For example, the services 632 may include the video content service described with reference to FIG. 3.

The platform 630 abstracts underlying functionality of hardware, such as server devices (e.g., included in the services 632) and/or software resources (e.g., included as the resources 634), and connects the example device 602 with other devices, servers, etc. The resources 634 may also include applications and/or data that can be utilized while computer processing is executed on servers that are remote from the example device 602. Additionally, the services 632 and/or the resources 634 may facilitate subscriber network services, such as over the Internet, a cellular network, or Wi-Fi network. The platform 630 may also serve to abstract and scale resources to service a demand for the resources 634 that are implemented via the platform, such as in an interconnected device embodiment with functionality distributed throughout the system 600. For example, the functionality may be implemented in part at the example device 602 as well as via the platform 630 that abstracts the functionality of the cloud 628.

Although aspects of reverse casting from a first screen device to a second screen device have been described in language specific to features and/or methods, the appended claims are not necessarily limited to the specific features or methods described. Rather, the specific features and methods are disclosed as example implementations of reverse casting from a first screen device to a second screen device, and other equivalent features and methods are intended to be within the scope of the appended claims. Further, various different embodiments are described and it is to be appreciated that each described embodiment can be implemented independently or in connection with one or more other described embodiments.

1. A method for reverse casting from a first screen device to a second screen device, the method comprising:
determining that the second screen device enters a location proximate to the first screen device based on the first screen device being connected to a local network and the second screen device entering the location and connecting to the local network;
associating the second screen device with the first screen device based on the determining that the second screen device enters the location proximate to the first screen device, the first screen device displaying video content prior to the associating, and the associating to enable data being synchronized between the first and second screen devices;
receiving, at the second screen device, contextual information that corresponds to the video content being displayed on the first screen device, the contextual information determined via an automated analysis of the video content that includes use of content signals, audio analysis of audio data and soundtracks, and image recognition techniques of video data; and
displaying, on the second screen device, the contextual information.

2. The method as recited in claim 1, wherein the video content displaying on the first screen device prior to the associating was initiated from a remote control of the first screen device, the remote control being a different device than the second screen device.

3. The method as recited in claim 1, wherein the associating is effective to enable the second screen device to act as a remote control of the first screen device.

4. The method as recited in claim 1, wherein the contextual information is displayed on the second screen device as media content options to display media content that is related to the video content being displayed on the first screen device.

5-7. (canceled)

8. The method as recited in claim 1, wherein:
the video content that is being displayed on the first screen device includes a music track; and
the contextual information at the second screen device includes a music video clip of the music track playing in the video content on the first screen device.

9. The method as recited in claim 1, further comprising:
displaying the contextual information on the second screen device as multiple video options for video clips related to the video content displaying on the first screen device.

10. A method for reverse casting from a first screen device to a second screen device, the method comprising:
displaying a synchronization user-selectable control in a user interface on the second screen device;
determining that the second screen device enters a location proximate to the first screen device based on the first screen device being connected to a local network and the second screen device entering the location and connecting to the local network;
receiving a user input via the synchronization user-selectable control;
associating the second screen device with the first screen device to enable data being synchronized between the first and second screen devices responsive to the user input of the synchronization user-selectable control, the first screen device displaying video content prior to the associating; and
receiving, at the second screen device, content identification of the video content being displayed on the first screen device, the content identification being received from the first screen device;
initiating a request for contextual information that corresponds to the video content being displayed on the first screen device, the request based on the content identification of the video content;
receiving, at the second screen device, the requested contextual information, the requested contextual information determined via an automated analysis of the video content that includes use of content signals, audio analysis of audio data and soundtracks, and image recognition techniques of video data; and
displaying the contextual information on the second screen device.

11-14. (canceled)

15. The method as recited in claim 10, wherein:
the video content that is being displayed on the first screen device includes a music track; and
the contextual information displaying on the second screen device includes a music video clip of the music track.

16. The method as recited in claim 10, wherein the contextual information is displayed on the second screen device as multiple video options for video clips related to the video content displaying on the first screen device.

17. The method as recited in claim 10, wherein the contextual information is displayed on the second screen device as purchasable media content, including at least one of media content, music content, and image content.

18. A mobile device implemented as a second screen device for reverse casting from a first screen device to the second screen device, the mobile device comprising:
an integrated display configured to display contextual information that corresponds to video content being displayed on the first screen device as media content options organized as panels in a viewport of the mobile device, the contextual information determined via an automated analysis of the video content that includes use of content signals, audio analysis of audio data and soundtracks, and image recognition techniques of video data;
a memory and processor system configured to execute a content display application as a computer application that is implemented to:
determine that the second screen device is proximate in location to the first screen device;
associate the second screen device with the first screen device based on the second screen device being proximate in location to the first screen device, the first screen device displaying the video content prior to the second screen device being associated with the first screen device, and the first and second screen devices associated to enable data being synchronized between the first and second screen devices; and
receive the contextual information from a video content service that distributes, to the first screen device, the video content being displayed on the first screen device.

19. The mobile device as recited in claim 18, wherein the contextual information corresponds to at least one of audio data or video data of the video content that is being displayed on the first screen device.

20. The mobile device as recited in claim 18, wherein the integrated display is configured to display the contextual information as media content options to display media content that is related to the video content being displayed on the first screen device.

21. (canceled)

22. The mobile device as recited in claim 18, wherein the media content options are selectable to initiate display of the contextual information of the video content being displayed on the first screen device.

23. The method as recited in claim 1, wherein the contextual information is a video clip of a news event recorded by a witness.

24. The method as recited in claim 1, wherein the automated analysis is performed in real-time on a live television program corresponding to the video content.

25. The method as recited in claim 1, wherein the automated analysis is performed by a cloud-based video content service.

26. The method as recited in claim 1, wherein the content signals are closed captions.

27. The method as recited in claim 1, wherein the automated analysis analyzes an action displayed in the video content and dynamically updates the contextual information based on the analysis.

28. The method as recited in claim 27, where the contextual information is a statistic associated with a participant performing the displayed action.
